(19) United States
(12) Patent Application Publication
(10) Pub. No.: US 2023/0031095 A1
(43) Pub. Date: Feb. 2, 2023

(54) METHOD AND SYSTEM FOR FACILITATING SUPPLY CHAIN FINANCE SERVICES

(71) Applicant: MASTERCARD INTERNATIONAL INCORPORATED, Purchase, NY (US)

(72) Inventors: Chris URBAN, Fairfax, VA (US); Kelly SEPIN, Eastchester, NY (US); David TRECKER, Mount Vernon, NY (US); Alonso ARAUJO, New York, NY (US); Murali Mohan VASUDEVA, Glenrock, NJ (US); Jasmine HOSEIN, New York, NY (US)

(73) Assignee: MASTERCARD INTERNATIONAL INCORPORATED, Purchase, NY (US)

(21) Appl. No.: 17/388,689

(22) Filed: Jul. 29, 2021

(51) Int. Cl. G06Q 40/02; G06Q 20/40; G06Q 20/02; G06Q 20/38

(52) U.S. Cl. CPC G06Q 40/02; G06Q 20/02; G06Q 20/387; G06Q 20/405; G06Q 30/04

(57) ABSTRACT

A method for facilitating advances in supply chain financing through a centralized platform includes: receiving a commitment message from a first entity system, wherein the commitment message includes at least a first transaction amount and a first payment date; receiving a financing offer from a second entity system, wherein the financing offer includes at least a second transaction amount less than the first transaction amount and a second payment date earlier than the first payment date; determining acceptance of the financing offer based on one or more predetermined criteria; transmitting the acceptance of the financing offer to the second entity system; and transmitting account data for a transaction account associated with the second entity system to the first entity system.

### FIELD

The present disclosure relates to facilitating payment advances in supply chain financing through a centralized platform, specifically using a centralized system to enable suppliers to be matched with available financing for outstanding invoices to enable immediate payment without affecting buyer pay schedules and requiring financers to provide onboarding.

### BACKGROUND

At its core, a supply chain involves a buyer that is interested in procuring goods and a supplier that interested in distributing those same goods. A supplier provides the goods to the buyer along with an invoice, where the buyer promises to pay the amount of the invoice at a predetermined date, which is often one or more months after delivery of the goods. With such a lag time on receiving payment for delivered goods, many suppliers face difficulty with keeping track of their cash flow and managing their finances in the most effective and efficient way.

As a result, many financial institutions and other entities have begun offering financing to suppliers. Financing often comes in the form of providing advanced payments to the supplier that align with outstanding invoices, or providing cash loans to the supplier that are repaid with proceeds from the outstanding invoices. However, because of the risks involved in such types of financing, many institutions are very restrictive in terms of the suppliers they are for which they willing to provide financing. Often, this results in only very large suppliers that have a significant buyer relationship being offered financing, while small businesses, which often are in greater need of financing, are left without options. Additionally, these same risks often result in a significant onboarding process for financers, which require an amount of time and expenditure of resources that may be difficult for small businesses to afford and may also make financers resistant to offering finances to smaller businesses. The result is that only a small portion of suppliers are even offered financing, thus providing little support to small businesses and preventing financers from gaining additional business.

Thus, there is a need for a technical platform that can serve as an intermediary between buyers, suppliers, and financers, which can enable more suppliers to have access to financing, more financers to be able to provide financing to suppliers, and be able to operate at a scale unavailable to any involved entities without such a platform, while also enabling buyers to continue their business without adjustment or disruption.

### SUMMARY

The present disclosure provides a description of systems and methods for facilitating technological advances in supply chain financing through a centralized platform. A centralized platform, referred to herein as a processing server, collects pay commitments from known buyers that receive invoices from known suppliers. The centralized platform makes these commitments available to interested financing entities, which are free to make decisions on financing to suppliers related to these commitments. The centralized platform collects offers from financers, ensures that they satisfy any requirements by the targeted supplier (e.g., fees, discounts, payment schedules, etc.) and, if the decision satisfies all such requirements, accepts the offer. The financing entity then pays the supplier accordingly, and the centralized platform lets the buyer (e.g., or a financial institution associated with the buyer) know of the deal so that the buyer can pay the financing entity directly using the underlying technology. The result is that financers and suppliers can be connected to one another without lengthy onboarding processes and little direct action, which enables suppliers to get paid immediately, and does so without affecting the buyer. Thus, there are technical improvements for all involved entities through the use of a specialized central platform that manages the relationships and can be scaled up to any level of participation.

A method for facilitating advances in supply chain financing through a centralized platform includes: receiving, by a receiver of a processing server, a commitment message from a first entity system, wherein the commitment message includes at least a first transaction amount and a first payment date; receiving, by the receiver of the processing server, a financing decision from a second entity system, wherein the financing decision includes at least a second transaction amount less than the first transaction amount and a second payment date earlier than the first payment date; determining, by a processor of the processing server, acceptance of the financing decision based on one or more predetermined criteria; transmitting, by a transmitter of the processing server, the acceptance of the financing decision to the second entity system; and transmitting, by the transmitter of the processing server, account data for a transaction account associated with the second entity system to the first entity system.

A system for facilitating advances in supply chain financing through a centralized platform includes: a first entity system; a second entity system; and a processing server, the processing server including a receiver receiving a commitment message from the first entity system, wherein the commitment message includes at least a first transaction amount and a first payment date, and receiving a financing decision from the second entity system, wherein the financing decision includes at least a second transaction amount less than the first transaction amount and a second payment date earlier than the first payment date, a processor determining acceptance of the financing decision based on one or more predetermined criteria, and a transmitter transmitting the acceptance of the financing decision to the second entity system, and transmitting account data for a transaction account associated with the second entity system to the first entity system.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for facilitating advances in supply chain financing through a centralized platform in accordance with exemplary embodiments.

FIG. 2 is a block diagram illustrating the processing server of the system of FIG. 1 for facilitating advances in supply chain financing through a centralized platform in accordance with exemplary embodiments.

FIGS. 3A and 3B are a flow diagram illustrating a process for facilitating advances in supply chain financing through a centralized platform in the system of FIG. 1 in accordance with exemplary embodiments.

FIG. 4 is a flow chart illustrating an exemplary method for facilitating advances in supply chain financing through a centralized platform in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Facilitating Supply Chain Financing

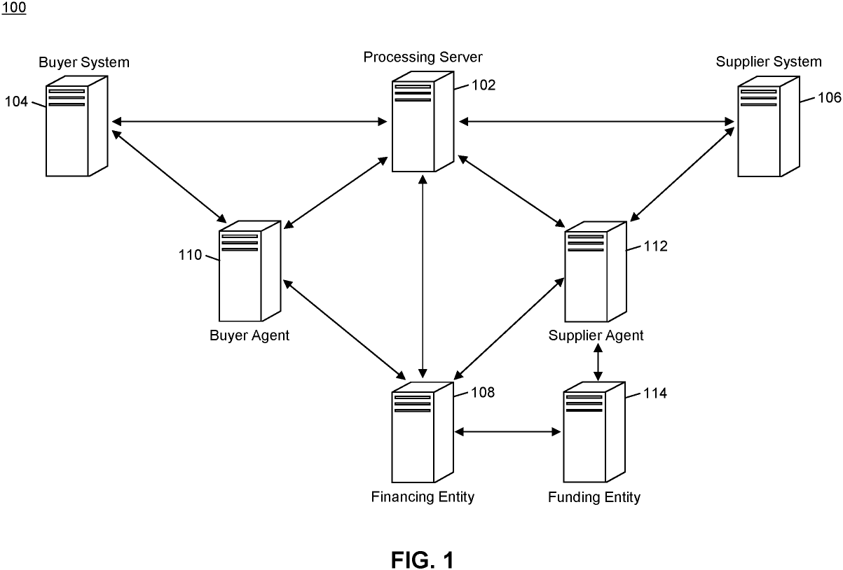

FIG. 1 illustrates a system 100 for facilitating advances in supply chain financing through a centralized platform.

The system 100 may include a processing server 102. The processing server 102, discussed in more detail below, may be a computing system that is configured to operate as a centralized platform for facilitating relationships and financing between buyers, suppliers, and financers in a supply chain network. The processing server 102 may be a single computing device or a plurality of computing devices that may be configured to perform the functions discussed herein.

The system 100 may include a buyer system 104 and supplier systems 106, which may be computing systems that are operated by, on behalf of, or are otherwise associated with a buyer and a supplier in a supply chain network. The supplier may provide goods or services to the buyer, and the supplier system 106 may electronically transmit an invoice to the buyer system 104 for the goods or services using any suitable communication network and method, such as via e-mail, an application programming interface, etc. The invoice may include reference numbers, product descriptions, serial numbers, names, addresses, supplier identification, buyer identification, or other data, including at least a payment amount owed by the buyer to the supplier and a payment date where the payment is due. In some cases, an invoice may have a payment schedule where multiple payments of predetermined amounts may be due at regular intervals. In some instances, the invoice may be sent from the supplier system 106 to the buyer system 104 using traditional methods, such as a paper invoice.

Traditionally, the buyer system 104 would receive the invoice and, at the determined due date, would make a payment for the stated payment amount to the supplier. In some instances, the buyer system 104 may utilize a buyer agent 110 for making payments, where the buyer agent 110 may be a bank or other institution that issues a transaction account to the buyer for use in making payments. The buyer agent 110 may be any entity that participates in the platform and acts on behalf of the buyer to transmit, receive, and process data transactions through the platform, which may include a financial institution or a non-financial entity. The transaction account may be, for example, a checking account, credit account, credit card, etc. When the buyer pays the supplier the payment amount included on the invoice, it may be paid from the transaction account the buyer has with the buyer agent 110. It will be apparent to persons having skill in the art that any functions performed herein by the buyer system 104 may be performed by the buyer agent 110, or, likewise, any functions performed by the buyer agent 110 may be performed by the buyer system 104, such as in cases where the buyer system 104 is a financial institution, where the buyer system 104 uses cash for payments, etc. In some embodiments, the buyer agent 110 may be another type of entity, such as a technology company, or any other entity that may operate on behalf of the buyer to perform the functions as discussed herein.

In some cases, the supplier may also have a supplier agent 112, which may be a bank or other institution that issues a transaction account to the supplier for use in receiving funds, such as payments made by buyers. The supplier agent 112 may be any entity that participates in the platform and acts on behalf of the supplier to transmit, receive, and process data transactions through the platform, which may include a financial institution or a non-financial entity. When the buyer pays the payment amount stated on an invoice to the supplier, payment may be made to the supplier agent 112 and the transaction account of the supplier credited accordingly. It will be apparent to persons having skill in the art that any functions performed herein by the supplier system 106 may be performed by the supplier agent 112, or, likewise, any functions performed by the supplier agent 112 may be performed by the supplier system 106, such as in cases where the supplier system 106 is a financial institution, where the supplier system 106 uses cash for payments, etc. In some instances, account information for the transaction account with the supplier agent 112 (e.g., account number, routing number, etc.) may be included in the invoice to provide the buyer system 104 with data for use in making an electronic payment to the supplier for fulfillment of the invoice. In some embodiments, the supplier agent 112 may be another type of entity, such as a technology company, or any other entity that may operate on behalf of the supplier to perform the functions as discussed herein.

In the system 100, the processing server 102 may operate a centralized platform to enable suppliers to receive financing including early or immediate payments on outstanding invoices through the use of partnered financing entities 108. When the buyer system 104 receives a new invoice from the supplier system 106, the buyer system 104 may make a promise to pay the stated payment amount on the invoice by the stated due date on the invoice. The promise to pay may be provided to the processing server 102 directly by the buyer system 104 or by the buyer agent 110 using any suitable communication network and method. For instance, the processing server 102 may have a platform accessible via one or more application programming interfaces that may be used by the buyer system 104, buyer agent 110, supplier system 106, and supplier agent 112 when communicating with the processing server 102.

The processing server 102 may receive the promise to pay and may make the invoice available for financing by an interested financing entity 108. Financing entities 108 may be banks, other financial institutions, or any entity that is interested in providing financing to suppliers on invoices submitted to the processing server 102 or that is interested in funding an early payment to the supplier. Invoices submitted by buyer systems 104 to the processing server 102 may be available to financing entities 108 via any suitable method, such as a web portal or application programming interface that shows financing entities 108 all available invoices. In some cases, invoices may be filtered by a financing entity 108 to show only those that match one or more desired criteria of the financing entity 108. For example, the financing entity 108 may have a maximum or minimum payment amount for which the financing entity 108 is interested in providing financing. In some cases, an invoice may be subject to one or more finance controls, as discussed below, where a financing entity 108 may filter invoices based on the applicable finance controls. In some embodiments, financing entities 108 may be provided with information regarding newly submitted invoices, such as through push notifications or other suitable methods.

Once the financing entity 108 identifies an outstanding invoice that it wishes to offer financing on, the financing entity 108 may electronically submit a financing offer to the processing server 102 using a suitable communication network and method. The financing offer may include information identifying the invoice (e.g., an invoice number, supplier identifier, buyer identifier, etc.) as well as any terms of the offer of finance. For instance, the financing offer may include one or more new payment amounts that may be less than the invoice’s stated payment amount (e.g., where any difference may be used as payment to the financing entity 108 or other involved entities for providing the financing) as well as a payment date that may be significantly earlier than the invoice’s stated payment date. For instance, in an example, the invoice may be for $100 to be paid by the buyer in 90 days, while the financing offer submitted by the financing entity 108 may be for $95 to be paid immediately. In such an example, the supplier may receive their payment immediately instead of waiting 90 days, but may give up $5 of the payment for the convenience, which may be collected by the financing entity 108 as payment for providing the financing and to account for risks involved in eventual payment being made by the buyer, where the processing server 102 may also collect a portion of such payments or a commission on financing provided by financing entities 108, as applicable. In such instances where there is a discount, all or a portion of the discount may be collected by one or more entities involved in the system 100, where the distribution of such amount may be based on agreements between the entities or other suitable criteria.

In some embodiments, the system 100 may include an addition system that may perform one or more functions for the financing entity 108 on behalf thereof, referred to herein as a secondary system, such as a funding entity 114, discussed in more detail below. In such embodiments, the secondary system may, for example, filter invoices based on criteria supplied by the financing entity 108, identify suitable invoices, generate financing offers, etc. In such instances, the secondary system may provide the generated financing offer to the financing entity 108 for approval, which may then forward the accepted financing offer to the processing server 102.

When the processing server 102 receives a financing offer (e.g., also referred to herein as a financing decision as the offer has already been approved by the financing entity 108), the processing server 102 may validate the financing offer to determine if it complies with one or more finance controls set by the supplier system 106 and/or supplier agent 112. Finance controls may be criteria set by the supplier or the supplier agent 112 that must be complied with for financing as desired by the supplier or supplier agent 112, such as payment amounts, payment dates, discount amounts, interest rates, terms, conditions, etc. For example, the supplier system 106 may submit an invoice to the buyer system 104 along with one or more finance controls that may be included in the invoice as submitted by the buyer system 104 to the processing server 102 or separately provided to the processing server 102 by the supplier system 106. For instance, the supplier system 106 may have an account registered with the processing server 102 to set finance controls for any and all invoices submitted to the processing server 102 for payment to the supplier system 106. In an example, the supplier system 106 may set finance controls that any financing offer must be for at most a 2% annual interest rate if the payment is received 60 days early. In such an example, when the processing server 102 receives the financing offer from the financing entity 108, the processing server 102 may ensure that the financing offer complies with both finance controls, otherwise the financing offer may be rejected. If the financing offer complies with all stated finance controls, then the processing server 102 (e.g., or other suitable system, such as the secondary system or financing entity 108) may accept the offer.

In some embodiments, the processing server 102 (e.g., or other suitable system) may be authorized to accept any offer that is received that is in compliance with provided finance controls. In other embodiments, the processing server 102 may provide the validated financing offer to the supplier system 106 and/or supplier agent 112 for approval prior to accepting the offer. In some cases, the processing server 102 may provide a time period for submission of offers by financing entities 108 and may, once the time period has expired, pick among several received and successfully validated financing offers for one financing offer to accept, such as based on the terms of the financing offer and any provided finance controls (e.g., one supplier system 106 may set a control for acceptance of the financing offer with the smallest possible discount, while another supplier system 106 may set a control for accepting the financing offer with the earliest payment date). In some cases, the processing server 102 or secondary system may prioritize financing entities 108 using other criteria, such as past relationships with the involved parties, where an attempt to use a first choice financing entity 108 may be attempted and, if rejected by the supplier system 106, the next choice financing entity 108 used.

When a financing offer is accepted by the processing server 102 (e.g., or other suitable system), the processing server 102 may electronically transmit an acceptance message to the financing entity 108 using a suitable communication network and method. The financing entity 108 may then provide payment to the supplier agent 112 or supplier system 106, as applicable, in accordance with the financing offer, such as by initiating an electronic payment transaction for the offered payment amount by the offered due date. In some embodiments, the processing server 102 may be a part of a payment network, and may process the electronic payment transaction. In some cases, the acceptance message may include the account details for the supplier’s transaction account with the supplier agent 112 to help facilitate payment by the financing entity 108 to the supplier agent 112. In some instances, the financing offer may be for multiple payments. In such instances, the financing entity 108 may initiate multiple payment transactions over time in accordance with the accepted financing offer. As a result of the electronic payment transaction, the supplier may receive payment for their invoice significantly earlier than the stated payment date in the invoice.

In some cases, the processing server 102 may electronically transmit a notification message to the supplier system 106 and/or supplier agent 112 when a financing offer is accepted. In such cases, the notification message may include the financing offer or terms included therein.

When the financing offer is accepted by the processing server 102 (e.g., or other suitable system), the processing server 102 may also electronically transmit a notification message to the buyer system 104 and/or buyer agent 110 to instruct the buyer to make payment on the invoice to the financing entity 108. In some cases, the notification message may include account details or other information necessary to ensure proper payment to the financing entity 108 or a transaction account of the financing entity’s choosing, such as, for example a notice of assignment indicating that invoices are assigned from the supplier to a funder. The buyer system 104 and/or buyer agent 110 may receive the notification message and may then initiate an electronic payment transaction for the payment amount stated in the invoice to the financing entity 108 on the due date as stated in the invoice. The financing entity 108 may then receive the full payment amount for the invoice, which may be greater than the financing amount paid to the supplier, where the difference may be the financing entity’s profit for providing the financing. In some cases, the processing server 102 may receive a portion of the difference as commission or payment for operation of the platform. In some embodiments, the buyer system 104, supplier system 106, financing entity 108, buyer agent 110, and/or supplier agent 112 may provide subscription payments or other payments for services as part of the operation of the platform.

In some instances, the buyer system 104 and/or buyer agent 110 may indicate an intent to pay instead of the immediate initiation of an electronic payment transaction to fulfill the invoice. In such instances, the payment schedule from the financing entity 108 to the supplier system 106 may be modified, such as to compensate for the increased risk. For example, the financing entity 108 may make a first advance payment to the supplier system 106 and may then make a payment for the remaining amount to the supplier system 106 once the buyer system 104 has made their payment. In such cases, the commission or fees involved may be modified or affected based on the buyer system’s intent to pay, the date of their payment, etc. The payment amounts of the financing entity 108 to the supplier system 106 may be similarly affected, such as varying the advance payment amount or date of payment of the remainder.

In some embodiments, the buyer system 104 may be able to utilize a payment card, such as a credit card or debit card, or other similar financial instrument for fulfilling the electronic payment for the invoice. In such cases, the processing server 102 may utilize a payment network or may utilize a third party system for processing an electronic payment transaction using a payment card. Such transactions may utilize an issuing financial institution and/or an acquiring financial institution and a processor (e.g., the payment network). In such instances, the buyer agent 110 and/or supplier agent 112 may be an issuing financial institution and/or the acquiring financial institution utilized as part of the electronic payment transaction using the payment card. Other payment methods may also be suitable for use in the methods and systems discussed herein, such as via cryptographic currency, wire-transfer, automated clearing house, etc.

In some embodiments, the system 100 may also include a funding entity 114. In such embodiments, the funding entity 114 may perform one or more functions of the financing entity 108. For example, a funding entity 114 may a bank or other entity that provides the funding for the financing offer that is paid to the supplier, while the financing entity 108 may be an entity or system that operates a platform for performing decisions, service, and management via the functions discussed herein. For instance, the funding entity 114 may use the platform provided by the financing entity 108 to set criteria for invoices that the funding entity 114 is willing to fund. The financing entity 108 may receive the criteria and, during the course of operation, identify invoices submitted to the processing server 102 by the supplier system 106 that satisfy the criteria desired by the funding entity 114. The financing entity 108 can (e.g., automatically or upon instructions received from the funding entity 114) submit approved offers for financing to the processing server 102 for use as discussed above. In these embodiments, funds provided by a funding entity 114 may be paid through the platform provided by the financing entity 108 or may be paid directly to a supplier agent 112, as applicable.

The methods and systems discussed herein thus provide for a centralized platform to enable financing, including approved payables financing and receivables financing in a supply chain network. Because the processing server 102 operates as an intermediary between participants, financing entities 108 can provide financing without having to perform any onboarding or diligence of supplier systems 106. In addition, supplier systems 106 do not have to contact or reach out to financing entities 108 and yet can still entertain financing offers from any number or financing entities 108 that participate in the system 100 through a single onboarding process as well as enabling the supplier systems 106 to be able to interact with a large number of buyers without having to enroll in multiple platforms. At the same time, buyer systems 104 can operate as normal, paying invoices at the normally stated due dates for the original invoice amounts, and may be offered discounts or rebates by suppliers, financing entities 108, buyer financial institutions 110, etc. for using the processing server 102. The result is a system 100 that provides for greater service, benefits, and savings to all involved entities with less resource expenditure and time investment, while, at the same time, being scalable significantly beyond existing systems, which can provide even further benefits and profits to supplier systems 106 and financing entities 108.

### Processing Server

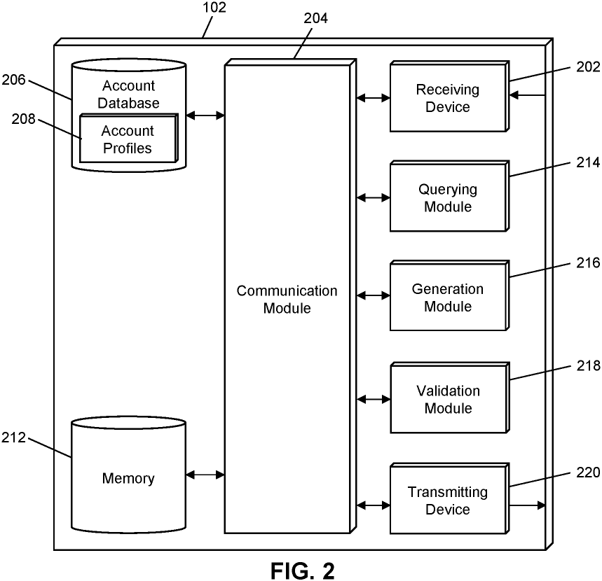

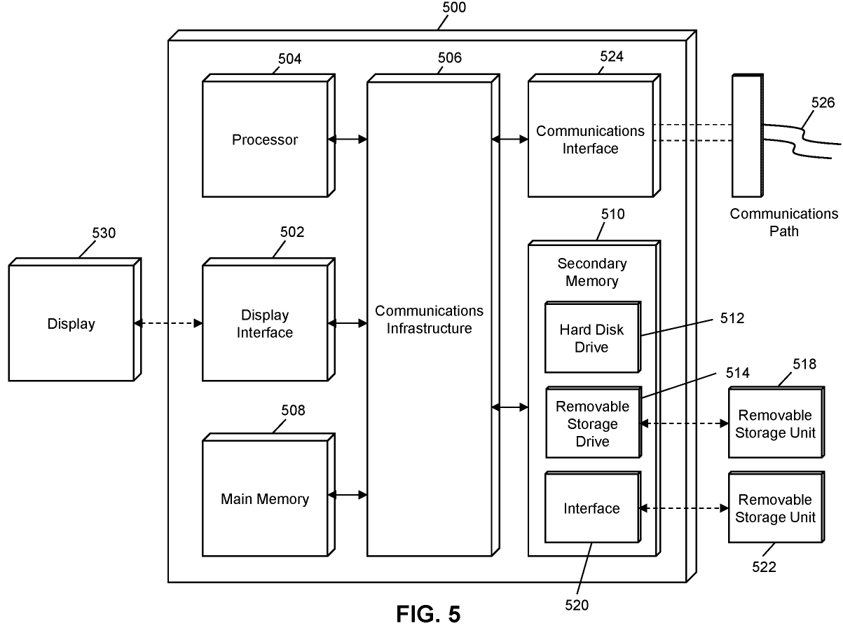

FIG. 2 illustrates an embodiment of a processing server 102, such as the processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from buyer systems 106, supplier systems 106, financing entities 108, buyer financial institutions 110, supplier financial institutions 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by buyer systems 104, supplier systems 106, buyer financial institutions 110, and supplier financial institutions 112 that may be superimposed or otherwise encoded with invoices, commitments to pay, finance controls, financing offer acceptance or decline messages, etc. The receiving device 202 may also be configured to receive data signals electronically transmitted by financing entities 108, which may be superimposed or otherwise encoded with financing offers, requests for finance control data, invoice filters, etc.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, validation module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to one or more registered accounts, such as an account registered to a supplier, buyer, or financing entity 108. For instance, a supplier’s registered account may include transaction account data, finance controls, invoice data, criteria for selecting financing offers, etc. A buyer’s registered account may include submitted invoices, submitted commitments to pay, buyer agent 110 information, etc. A financing entity’s registered account may include, for example, transaction account data, submitted financing offers, accepted financing offers, assigned invoices, etc.

The processing server 102 may also include a memory 212. The memory 212 may be configured to store data for use by the processing server 102 in performing the functions discussed herein, such as public and private keys, symmetric keys, etc. The memory 212 may be configured to store data using suitable data formatting methods and schema and may be any suitable type of memory, such as read-only memory, random access memory, etc. The memory 212 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 212 may be comprised of or may otherwise include a relational database that utilizes structured query language for the storage, identification, modifying, updating, accessing, etc. of structured data sets stored therein. The memory 212 may be configured to store, for example, cryptographic keys, salts, nonces, communication information for other computing systems, transaction processing standards and rules, payment network data, finance controls, submitted invoices, submitted financing offers, transaction account data, etc.

The processing server 102 may include a querying module 214. The querying module 214 may be configured to execute queries on databases to identify information. The querying module 214 may receive one or more data values or query strings, and may execute a query string based thereon on an indicated database, such as the state database 206 of the processing server 102 to identify information stored therein. The querying module 214 may then output the identified information to an appropriate engine or module of the processing server 102 as necessary. The querying module 214 may, for example, execute a query on the account database 206 to identify an account profile 208 associated with a supplier system 106 associated with an invoice for which a financing offer is received, such as to identify financing controls for use in validating the received financing offer.

The processing server 102 may also include a generation module 216. The generation module 216 may be configured to generate data for use by the processing server 102 in performing the functions discussed herein. The generation module 216 may receive instructions as input, may generate data based on the instructions, and may output the generated data to one or more modules of the processing server 102. For example, the generation module 216 may be configured to generate notification messages, acceptance messages, decline messages, payment information, interfaces, application programming interface data, etc.

The processing server 102 may also include a validation module 218. The validation module 218 may be configured to perform validations for the processing server 102 as part of the functions discussed herein. The validation module 218 may receive instructions as input, which may also include data to be used in performing a validation, may perform a validation as requested, and may output a result of the validation to another module or engine of the processing server 102. The validation module 218 may, for example, be configured to validate received financing offers to ensure compliance with one or more finance controls, validate that payment instructions are eligible for financing, validate that the buyer system 104 and supplier system 106 are actively enrolled in the platform, etc. The validation module 218 may also be configured to select one of a plurality of validated financing offers for acceptance, such as based on data included in an associated account profile 208.

The processing server 102 may also include a transmitting device 220. The transmitting device 220 may be configured to transmit data over one or more networks via one or more network protocols. In some instances, the transmitting device 220 may be configured to transmit data to buyer systems 106, supplier systems 106, financing entities 108, buyer financial institutions 110, supplier financial institutions 112, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to buyer systems 106, supplier systems 106, buyer financial institutions 110, and supplier financial institutions 112, which may be superimposed or otherwise encoded with notification messages, requests for invoice data, transaction account data, requests for financing offer acceptance or decline, etc. The transmitting device 220 may also be configured to electronically transmit data signals to financing entities 108 that may be superimposed or otherwise encoded with available invoices, filtered invoice data, financing offer acceptance or decline messages, transaction account data, etc.

### Process For Facilitating Supply Chain Financing

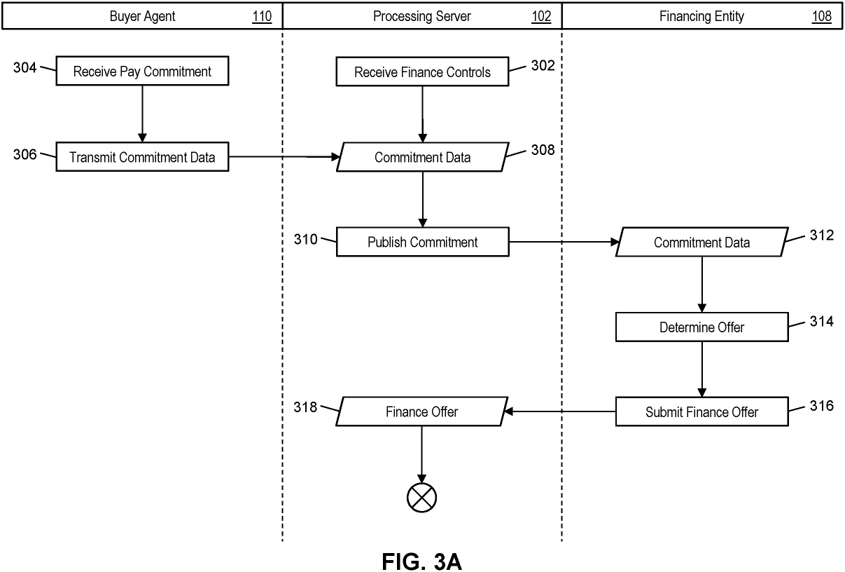

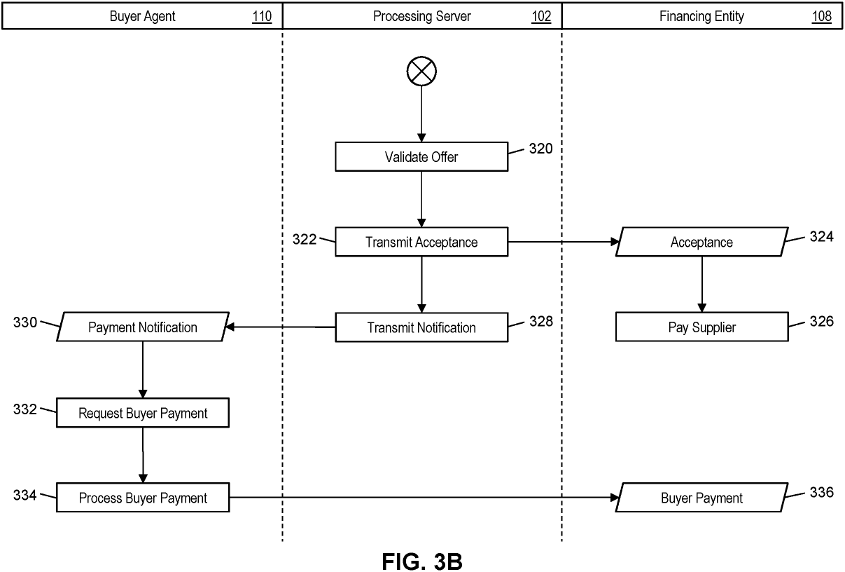

FIGS. 3A and 3B illustrate a process for facilitating advances in supply chain financing through a centralized platform provided by the processing server 102 in the system 100 of FIG. 1.

In step 302, the receiving device 202 of the processing server 102 may receive one or more finance controls from a supplier system 106. The finance controls may be stored in an account profile 208 associated with the supplier system 106 in the account database 206 of the processing server 102. In some cases, the finance controls may be generated or otherwise identified by a supplier agent 112 that are provided to the supplier system 106 for receipt by the processing server 102. In some instances, the finance controls may be received from a supplier agent 112 instead of the supplier system 106. In step 304, the buyer agent 110 may receive a commitment to pay an invoice from a buyer system 104. The commitment to pay may include invoice data including at least a supplier identifier, a payment amount, and a due date for the payment amount. In step 306, the buyer agent 110 may electronically transmit the commitment data to the processing server 102 to submit the corresponding invoice to the centralized platform to make it available for financing. In step 308, the receiving device 202 of the processing server 102 may receive the commitment data using a suitable communication network and method.

In step 310, the processing server 102 may publish the commitment via the publishing of the invoice or corresponding data indicating availability of the invoice for financing. In some cases, the invoice may be published via a web page, application program, or application programming interface accessible by one or more financing entities 108. In some instances, the processing server 102 may first identify the account profile 208 of the associated supplier (e.g., using the supplier identifier from the commitment data) and may include one or more finance controls stored in the account profile 208 in the published invoice data. In some instances, the data may be published via a push notification or other notification message electronically transmitted (e.g., via the transmitting device 220) to the financing entity 108 by the processing server 102 using a suitable communication network and method.

In step 312, the financing entity 108 may receive the commitment data, which may include at least the payment amount and due date stated in the invoice. In step 314, the financing entity 108 may determine a financing offer to make on the invoice. The financing offer may be for a transaction amount that is less than the payment amount stated in the invoice, and for payment on a date that is earlier than the due date stated in the invoice. In some cases, the financing offer may be validated and accepted for submission to the processing server 102, such as via the supplier, the supplier agent 112, or another entity, such as a funding entity 114. In step 316, the financing entity 108 may submit the financing offer to the processing server 102 using any suitable communication network and method, such as an application programming interface used to interface with the centralized platform provided by the processing server 102. In instances where the system 100 includes a secondary system (e.g., funding entity 114), functions performed in steps 314 and 316 may be performed by the secondary system, such as determining the financing offer, approving the financing offer, and transmitting the financing offer to the processing sever 102. In step 318, the receiving device 202 of the processing server 102 may receive the financing offer. The financing offer may include the transaction amount and payment date, and may also include any additional information suitable for performing the functions discussed herein, such as transaction account data for payments to be made to the financing entity 108, identification information for the invoice to which the financing offer pertains, etc.

In step 320, the validation module 216 of the processing server 102 may validate the financing offer. Validation of the financing offer may include validating that the financing offer is in compliance with any applicable finance controls, such as may be set by the supplier system 106 or supplier agent 112, which may be identified in an account profile 208 associated therewith stored in the account database 206 of the processing server 102. For instance, the validation module 216 may ensure that the financing offer is for a sufficient payment and on a schedule that is acceptable by the supplier. In some embodiments, validation of the financing offer may be performed by the financing entity 108 or funding entity 114, as applicable. In such embodiments, the processing server 102 may receive the already validated offer in step 316. Upon successful validation of the financing offer, then, in step 322, the transmitting device 220 of the processing server 102 may electronically transmit an acceptance message for acceptance of the financing offer to the financing entity 108 using a suitable communication network and method. In step 324, the financing entity 108 may receive the acceptance message, which may include information identifying the financing offer as well as transaction account data for the transaction account to which the financing payment(s) is/are to be made, such as may have been identified in the account profile 208 associated with the supplier system 106 or supplier agent 112. In step 326, the financing entity 108 may initiate an electronic payment transaction for payment of the financing amount to the supplier agent 112 by the indicated date. In embodiments where the system 100 includes a funding entity 114, the funding entity 114 may initiate the electronic payment transaction, such as in response to an instruction provided by the financing entity 108 in step 326.

In step 328, the transmitting device 220 of the processing server 102 may electronically transmit a notification message to the buyer agent 110 using a suitable communication network and method. The notification message may include information identifying the invoice and may notify the buyer agent 110 that payment for the invoice is to be made to the financing entity 108 and may further include transaction account data for a transaction account designated by the financing entity 108 for receiving invoice payments. In some embodiments, the transmitting device 220 of the processing server 102 may also electronically transmit a notification message to the supplier agent 112 notifying the supplier agent 112 of the accepted offer and the upcoming payment. In step 330, the buyer agent 110 may receive the notification message from the processing server 102. In step 332, the buyer agent 110 may request payment from the buyer system 104 on the payment date stated in the invoice, or may identify a transaction account associated with the buyer system 104 and debit the transaction account for the stated payment amount in the invoice on the payment date. In step 334, the buyer agent 110 may initiate an electronic payment transaction for payment of the stated payment amount in the invoice to the transaction account designated by the financing entity 108. In step 336, the financing entity 108 may receive the payment from the buyer. In embodiments where the system 100 includes a funding entity 114, the funding entity 114 may receive the payment, such as may be forwarded on by the financing entity 108 or provided directly to the funding entity 114 instead of the financing entity 108.

### Process For Facilitating Advances in Supply Chain Financing

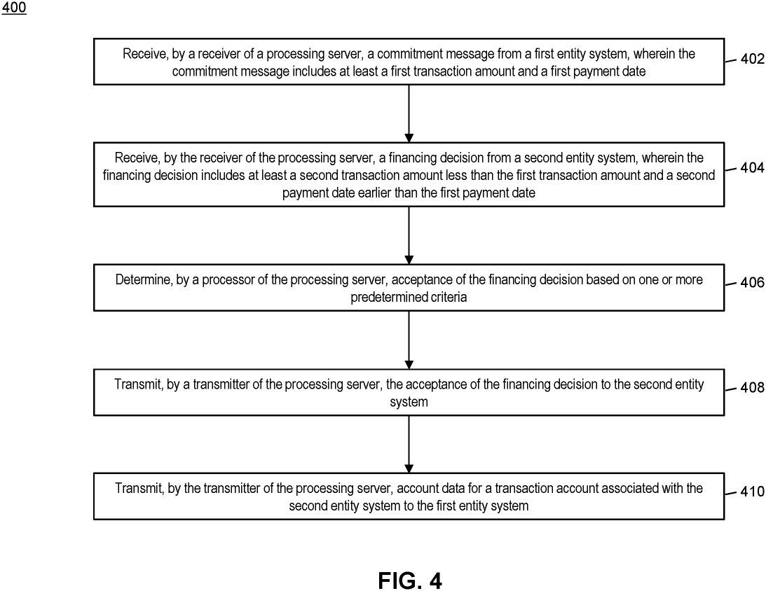

FIG. 4 illustrates a process 400 for the facilitating advances in supply chain financing through the use of a centralized platform that operates as an intermediary for participant systems.

In step 402, a commitment message may be received by a receiver (e.g., receiving device 202) of a processing server (e.g., processing server 102) from a first entity system (e.g., buyer system 106, buyer agent 110, etc.), wherein the commitment message includes at least a first transaction amount and a first payment date. In step 404, a financing decision may be received by the receiver of the processing server from a second entity system (e.g., financing entity 108), wherein the financing decision includes at least a second transaction amount less than the first transaction amount and a second payment date earlier than the first payment date.

In step 406, acceptance of the financing decision may be determined by a processor (e.g., validation module 216) of the processing server based on one or more predetermined criteria. In step 408, the acceptance of the financing decision may be transmitted by a transmitter (e.g., transmitting device 220) of the processing server to the second entity system. In step 410, account data for a transaction account associated with the second entity system may be transmitted by the transmitter of the processing server to the first entity system.

In one embodiment, the method 400 may further include processing, by the processor of the processing server, an electronic payment transaction for payment of the first transaction amount to the transaction account associated with the second entity system on the first payment date. In some embodiments, the method 400 may also include processing, by the processor of the processing server, a first electronic payment transaction for payment of the second transaction amount from the transaction account associated with the second entity system on the second payment date. In a further embodiment, the method 400 may even further include processing, by the processor of the processing server, a second electronic payment transaction for payment of a third transaction amount from the transaction account associated with the second entity system on the first payment date. In an even further embodiment, a sum of the second transaction amount and the third transaction amount may be less than the first transaction amount.

In one embodiment, the method 400 may further include validating, by the processor (e.g., validation module 216) of the processing server, the financing offer based on one or more finance controls, wherein the one or more predetermined criteria includes successful validation of the financing offer. In a further embodiment, the one or more finance controls may include at least one of: discount amount and payment period. In another further embodiment, the method 400 may also include receiving, by the receiver of the processing server, the one or more finance controls from a third entity system (e.g., supplier system 106, supplier agent 112, etc.) prior to receiving the commitment message. In an even further embodiment, the commitment message may include an identification value associated with the third entity system. Computer System Architecture

FIG. 5 illustrates a computer system 500 in which embodiments of the present disclosure, or portions thereof, may be implemented as computer-readable code. For example, the processing server 102 of FIGS. 1 and 2 may be implemented in the computer system 500 using hardware, non-transitory computer readable media having instructions stored thereon, or a combination thereof and may be implemented in one or more computer systems or other processing systems. Hardware may embody modules and components used to implement the methods of FIGS. 3A, 3B, and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3A, 3B, and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for facilitating advances in supply chain financing through a centralized platform. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method for facilitating advances in supply chain financing through a centralized platform, comprising:
receiving, by a receiver of a processing server, a finance control from a supplier entity system, the finance control being a financing criteria for a transaction;
receiving, by the receiver of a processing server, a commitment message from a first entity system, wherein the commitment message includes at least a first transaction amount and a first payment date;
receiving, by the receiver of the processing server, a financing offer from a second entity system, wherein the financing offer includes at least a second transaction amount less than the first transaction amount and a second payment date earlier than the first payment date;
validating, by a processor of the processing server, the financing offer based on the finance control;
determining, by the processor of the processing server, acceptance of the financing offer based on successful validation of the financing offer ;
transmitting, by a transmitter of the processing server, the acceptance of the financing offer to the second entity system; and
transmitting, by the transmitter of the processing server, account data for a transaction account associated with the second entity system to the first entity system.

2. The method of claim 1, further comprising:
processing, by the processor of the processing server, an electronic payment transaction for payment of the first transaction amount to the transaction account associated with the second entity system on the first payment date.

3. The method of claim 1, further comprising:
processing, by the processor of the processing server, a first electronic payment transaction for payment of the second transaction amount from the transaction account associated with the second entity system on the second payment date.

4. The method of claim 3, further comprising:
processing, by the processor of the processing server, a second electronic payment transaction for payment of a third transaction amount from the transaction account associated with the second entity system on the first payment date.

5. The method of claim 4, wherein a sum of the second transaction amount and the third transaction amount is less than the first transaction amount.

6. (canceled)

7. (canceled)

8. The method of claim 1, wherein the commitment message includes an identification value associated with the supplier entity system.

9. The method of claim 1, wherein the finance control includes at least one of: a discount amount and a payment period.

10. A system for facilitating advances in supply chain financing through a centralized platform, comprising:
a supplier entity system;
a first entity system;
a second entity system; and
a processing server, the processing server including:
a receiver configured to:
receive a finance control from a supplier entity system, the finance control being a financing criteria for a transaction;
receive a commitment message from the first entity system, wherein the commitment message includes at least a first transaction amount and a first payment date, and
receive a financing offer from the second entity system, wherein the financing decision includes at least a second transaction amount less than the first transaction amount and a second payment date earlier than the first payment date, a processor configured to:
validate the financing offer based on the finance control;
determine acceptance of the financing of offer based on successful validation of the financing offer , and a transmitter configured to:
transmit the acceptance of the financing decision to the second entity system, and
transmit account data for a transaction account associated with the second entity system to the first entity system.

11. The system of claim 10, wherein the processor of the processing server further processes an electronic payment transaction for payment of the first transaction amount to the transaction account associated with the second entity system on the first payment date.

12. The system of claim 10, wherein the processor of the processing server further processes a first electronic payment transaction for payment of the second transaction amount from the transaction account associated with the second entity system on the second payment date.

13. The system of claim 12, wherein the processor of the processing server further processes a second electronic payment transaction for payment of a third transaction amount from the transaction account associated with the second entity system on the first payment date.

14. The system of claim 13, wherein a sum of the second transaction amount and the third transaction amount is less than the first transaction amount.

15. (canceled)

16. (canceled)

17. The system of claim 10, wherein the commitment message includes an identification value associated with the supplier entity system.

18. The system of claim 10, wherein the finance control includes at least one of: a discount amount and a payment period.
